(19) United States
(12) Patent Application Publication
(10) Pub. No.: US 2013/0317784 A1
(43) Pub. Date: Nov. 28, 2013

(54) Method for the Design of Uniform Waveguide Light Extraction

(71) Applicants: Jiandong Huang, Vancouver, WA (US); Apostolos T. Voutsas, Portland, OR (US)

(72) Inventors: Jiandong Huang, Vancouver, WA (US); Apostolos T. Voutsas, Portland, OR (US)

(21) Appl. No.: 13/477,922

(22) Filed: May 22, 2012

(51) Int. Cl. G06F 17/50

(52) U.S. Cl. 703/1

(57) ABSTRACT

A system and method are provided for designing a waveguide with uniform light extraction. Due to the complex nature of the calculations required, the method may be enabled as a set of software instructions, stored as a sequence of steps in a non-transitory memory for execution by a processor. The method accepts parameters for a waveguide panel, light sources, and light extraction features associated with the waveguide panel. Also accepted as an input are target light extraction goals. The method divides the waveguide panel into n subpanels, where n is an integer greater than 1. For each subpanel, waveguide propagation restrictions are defined. The light extraction features are modeled for each subpanel in response to the target extraction goals, and the waveguide, panel is designed using the light extraction features modeled for each subpanel.

### BACKGROUND OF THE INVENTION

1. Field of the Invention

This invention generally relates to light waveguide mediums and, more particularly, to a system and method for designing waveguides to meet light extraction criteria.

2. Description of the Related Art

FIG. 1 is a plan view of representing light extracted from a liquid crystal display (LCD) backlight (prior art). Mura is a Japanese term for unevenness, inconsistency in physical matter, or human spiritual condition. This word is used in LCD to describe undesired illumination non-uniformity due to design or fabrication defects. Mura can come from both front and hack panels. As shown in the figure, more light is being extracted near the input light emitting devices (LEDs) on the left side of the panel, than on the right side of the panel. The significant amount of light extracted near the light source leaves an insufficient amount of light to be extracted from the right side of the panel. Backlight panels are conventionally designed using a significant degree of trial-and-error to find the correct balance of light extraction and illumination.

It would be advantageous if backlight panels and waveguide devices could be designed with a minimum of trial-and, error analysis.

### SUMMARY OF THE INVENTION

Disclosed herein is a design method that can be used to design liquid crystal display (LCD) backlights with controlled emission intensity profiles to reduce mura effects from the backlight. Generally, the angular distributions and uniformity targets for the backlight waveguide are determined. Then, the structure of the light extraction features are optimized for the angular distributions, and density of the light extraction features are optimized for intensity. Simultaneously, light propagation through the waveguide must be balancing with the light emission characteristics.

Accordingly, a method is provided for designing a waveguide with uniform light extraction. Due to the complex nature of the calculations required, the method may be enabled as a set of software instructions, stored as a sequence of steps in a non-transitory memory for execution by a processor. The method accepts parameters for a waveguide panel, light sources, and light extraction features associated with the waveguide panel. Also accepted as an input are target light extraction goals. The method divides the waveguide panel into n subpanels, where n is an integer greater than 1. For each subpanel, waveguide propagation restrictions are defined. The light extraction features are modeled for each subpanel in response to the target extraction goals, and the waveguide panel is designed using the light extraction features modeled for each subpanel.

Some examples of light extraction features include the waveguide top surface roughness, microstructures embedded in the waveguide panel, microstructures overlying the waveguide panel, and combinations of the above-referenced features. Some examples of light propagation restrictions include the intensity of light entering a subpanel, the intensity of light propagated to a subsequent subpanel, angular deflection of light through a subpanel, and the intensity of reflected light entering a subpanel. Some examples of target light extraction goals include the uniformity of light intensity exiting a top surface of the waveguide panel, light exiting a bottom surface of the waveguide panel, light angles exiting the top and bottom surfaces of the waveguide panel, and spatial resolution between light exiting regions.

Additional details of the above-described method and a system for designing a waveguide with uniform light extraction are provided below.

### BRIEF DESCRIPTION OF THE DRAWINGS

FIG. 1 is a plan view of representing light extracted from a liquid crystal display (LCD) backlight (prior art).

FIG. 2 is a schematic block diagram of a system for designing a waveguide with uniform light extraction.

FIG. 3 is a partial cross-sectional view of an exemplary waveguide design.

FIG. 4 is a plan view of a subpanel divided into segments.

FIG. 5 is a graph depicting the intensity of light extracted from subpanel 302-0, before and after segmentation.

FIGS. 6A and 6B are, respectively, graphs depicting target goals for light extraction angles and intensity.

FIGS. 7A and 7B depict, respectively, initial light intensity extraction modeling, followed by a subsequent modeling iteration.

FIG. 8 is a partial cross-sectional view of a waveguide panel showing angular deflection of light propagating through the panel with two light sources.

FIG. 9 depicts polar graphs of light extraction angles as a function of the shape of a pyramid-shaped light extraction feature.

FIGS. 10A through 10E depict modeling with the objective of obtaining target angular and intensity light extraction goals.

FIG. 11 is a graph depicting the relationship between light intensity (A) and the decay length (τ) of light of light propagation through the waveguide.

FIG. 12 is a graph depicting different extraction rates (using decay lengths) for extraction cells with various light extraction structures having the same cell densities.

FIGS. 13A and 13B depict the relationship between the sizes of pyramids and light intensity (FIG. 13A), and decay length (FIG. 13B).

FIGS. 14A through 14E depict an example of a waveguide design begun by divided a panel into four subpanels (n=4).

FIGS. 15A through 15G represent a modification to the design of FIGS. 14A through 14E.

FIG. 16 is a flowchart illustrating a set of software instructions, stored as a sequence of steps in a non-transitory memory for execution by a processor, for designing a waveguide with uniform light extraction.

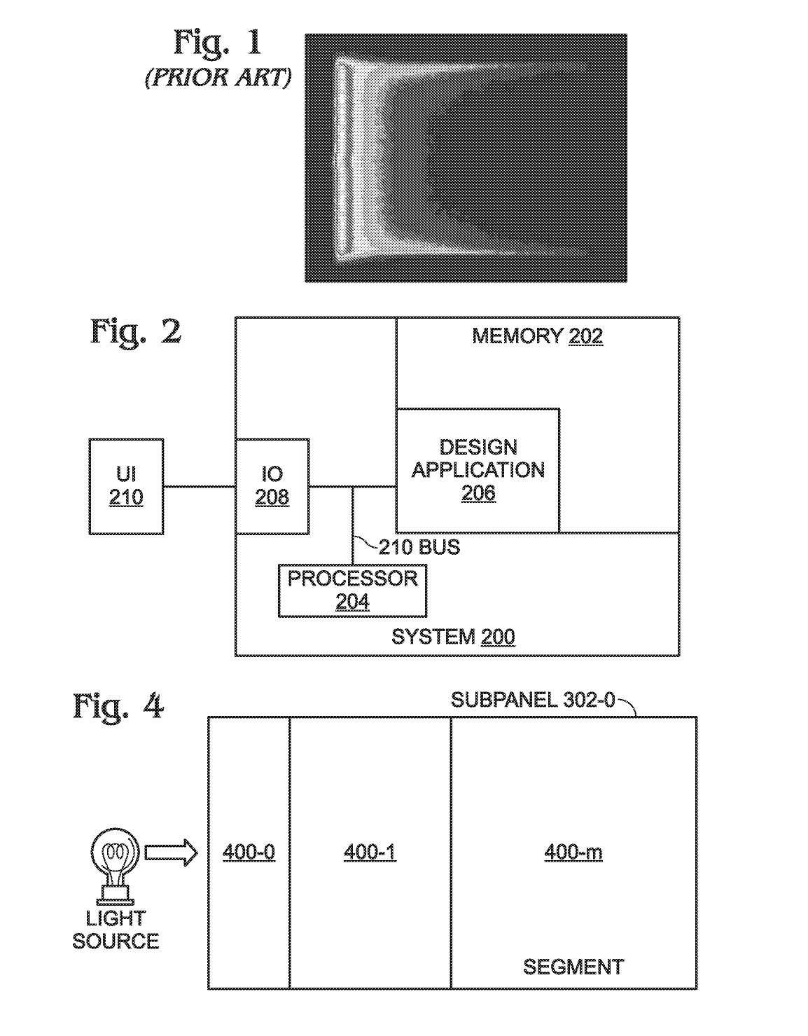

### DETAILED DESCRIPTION

FIG. 2 is a schematic block diagram of a system for designing a waveguide with uniform light extraction. The system 200 comprises a non-transitory memory 202 and a processor 204. A design application 206 is enabled as a sequence of instructions stored in the memory 202 and executed by the processor 204. The design application 206 has an input/output (10) interface 208 associated with a user interface (UI) 210 for accepting parameters for a waveguide panel, such as light sources, light extraction features associated with the waveguide panel, and first target extraction goals. The UI 210 may be comprised of a display, printer, and keyboard, for example. The design application results may also be presented via the UI 210.

As used in this application, the terms “component,” “module,” “system,” “application”, and the like may refer to an automated computing system entity, such as hardware, firmware, a combination of hardware and software, software, software stored on a computer-readable medium, or software in execution. For example, a system may be, but is not limited to being, a process running on a processor, a processor, an object, an executable, a thread of execution, a program, and/or a computer. By way of illustration, both an application running on a computing device and the computing device can be a system. One or more systems can reside within a process and/or thread of execution and a system may be localized on one computer and/or distributed between two or more computers. In addition, these components can execute from various computer readable media having various data structures stored thereon. The components may communicate by way of local and/or remote processes.

The design application 206 may employ a computer system with a bus 210 or other communication mechanism for communicating information, and a processor 204 coupled to the bus for processing information. The system memory 202 may include a random access memory (RAM) or other dynamic storage device, coupled to the bus 210 for storing information and instructions to be executed by a processor 204. These memories may also be referred to as a computer-readable medium. The execution of the sequences of instructions contained in a computer-readable medium may cause a processor to perform some of the steps associated with the designing the waveguide. Alternately, some of these functions may be performed in hardware, such as a field programmable gate array (FPGA) or a dedicated hardware application-specific integrated circuit (ASIC). The practical implementation of such a computer system would be well known to one with skill in the art.

As used herein, the term “computer-readable medium” refers to any medium that participates in providing instructions to a processor for execution. Such a medium may take many forms, including but not limited to, non-volatile media, volatile media, and transmission media. Non-volatile media includes, for example, optical or magnetic disks. Volatile media includes dynamic memory. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

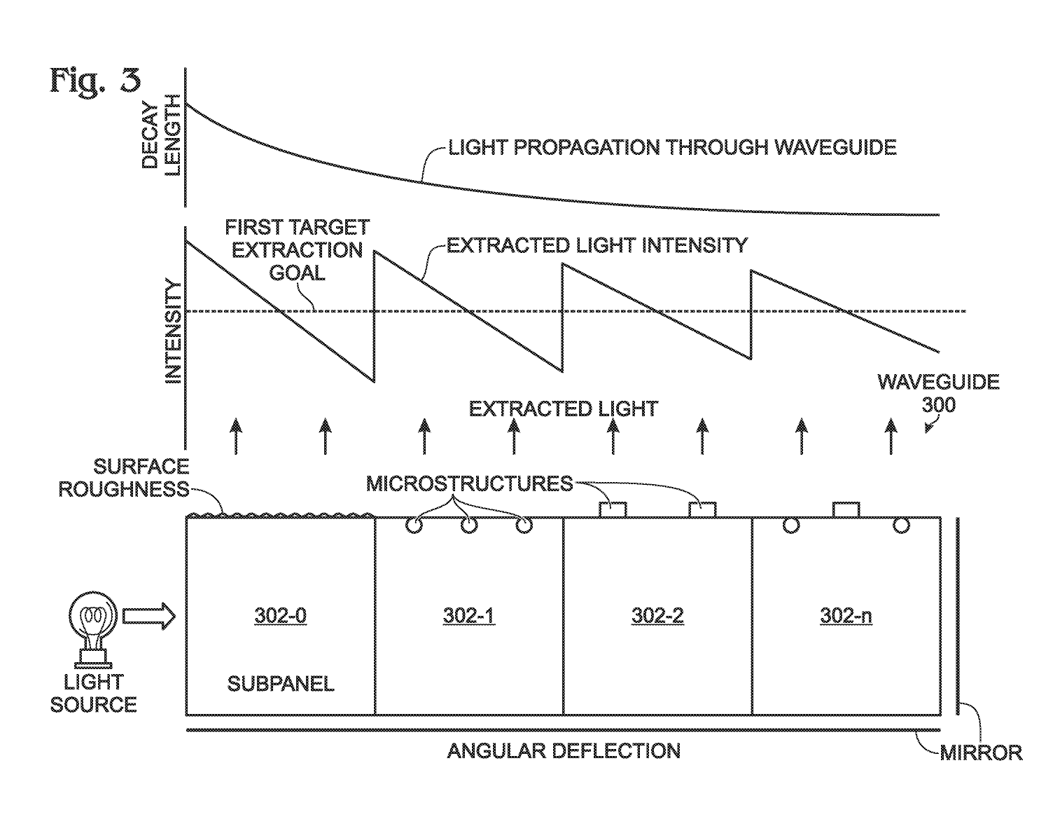

FIG. 3 is a partial cross-sectional view of an exemplary waveguide design. The design application divides the waveguide panel 300 into n subpanels, 302-0 through 302-n where n is an integer greater than 1. As shown in this example, n=4. The design application defines waveguide propagation restrictions for each subpanel, models the light extraction features 304 for each subpanel in response to the first target extraction goals, and designs the waveguide, panel using the light extraction features modeled for each subpanel.

Some examples, of light extraction features include waveguide top surface roughness (302-0), microstructures embedded in the waveguide panel (302-1), microstructures overlying the waveguide panel (302-3), and combinations of the above-referenced features (302-n). The microstructures may be, for example, varied by size, shape(s), placement, and density. Typically, the waveguide is designed with a single type of light extraction feature, which may be modified for use in different subpanels. However, it is also possible to use multiple types light extraction features for a waveguide, or for a waveguide subpanel. Explicit details of microstructures overlying the waveguide top surface are presented below, and the principles of embedded microstructure may be extracted therefrom.

Some examples of light propagation restrictions include the intensity of light entering a subpanel, the intensity of light propagated to a subsequent subpanel, angular deflection of light through a subpanel, and the intensity of reflected light entering the subpanel. As discussed in greater detail below, some examples of first target light extraction goals include the uniformity of light intensity exiting a top surface of the waveguide panel, light exiting a bottom surface of the waveguide panel (intensity and angle), light angles exiting the top and bottom surfaces of the waveguide panel, and spatial resolution between light exiting regions.

FIG. 4 is a plan view of a subpanel divided into segments. As shown in the extracted light intensity representation of FIG. 3A, dividing the waveguide into subpanels creates discrete responses of extracted intensity. Each discrete response can be further refined by breaking the waveguide into smaller sections. Therefore, subsequent to modeling the light extraction features for subpanel 302-0, for example, the design application may divide the subpanel into a plurality of segments 400-0 through 400-m. In this example, m=3. After accepting segment light extraction goals, light extraction features are modeled in response to the segment light extraction goals for each first subpanel segment, and subpanel 302-0 is designed using the light extraction features modeled for each segment. Further, every subpanel can be divided into a plurality of segments, with segment light extraction goals for each subpanel, so that the light extraction features for the segments can be modeled in each subpanel.

FIG. 5 is a graph depicting the intensity of light extracted from subpanel 302-0, before and after segmentation. From studying the exemplary light propagation through the waveguide curve presented in FIG. 4, it can be seen that each succeeding subpanel has less light entering it, so that each succeeding subpanel must be more efficient in extracting light. Likewise, each succeeding segment in a subpanel accepts an increasing smaller amount of propagated light. Therefore, the design application defines the intensity of light entering each segment of subpanel 302-0, and adjusts the light extraction feature modeling of subpanel segments 400-0 through 400-m in response to redefining the intensity of light entering each segment. By extension, if every subpanel is divided into a plurality of segments, the intensity of light entering each segment is defined for each sub-panel, and the light extraction features for each segment in each subpanel are adjusted in response to redefining the intensity of light entering each segment.

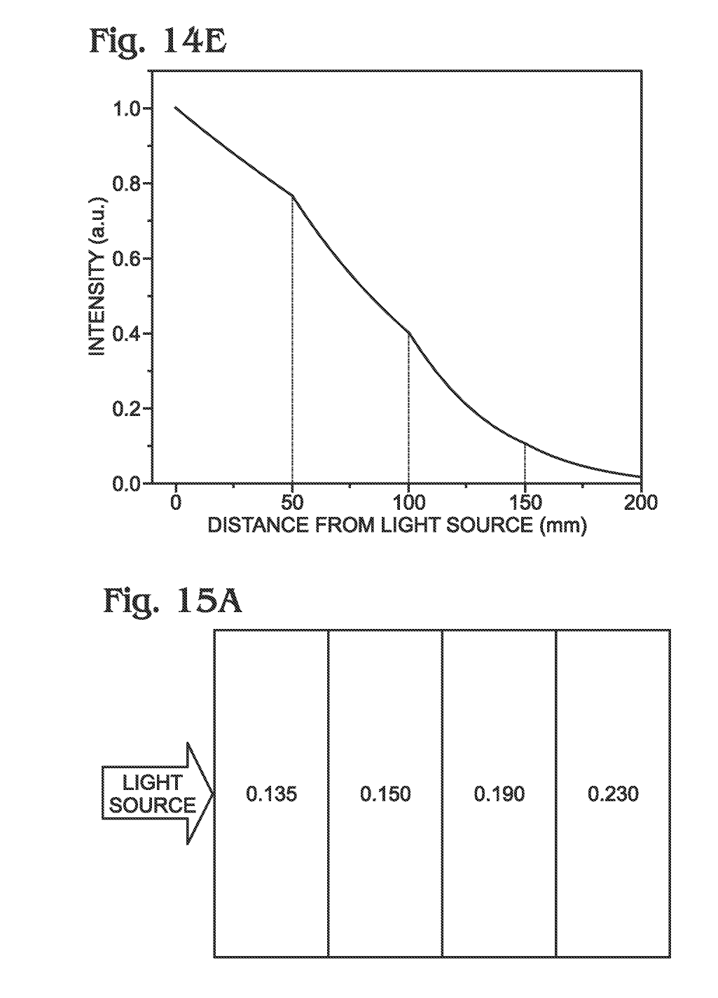

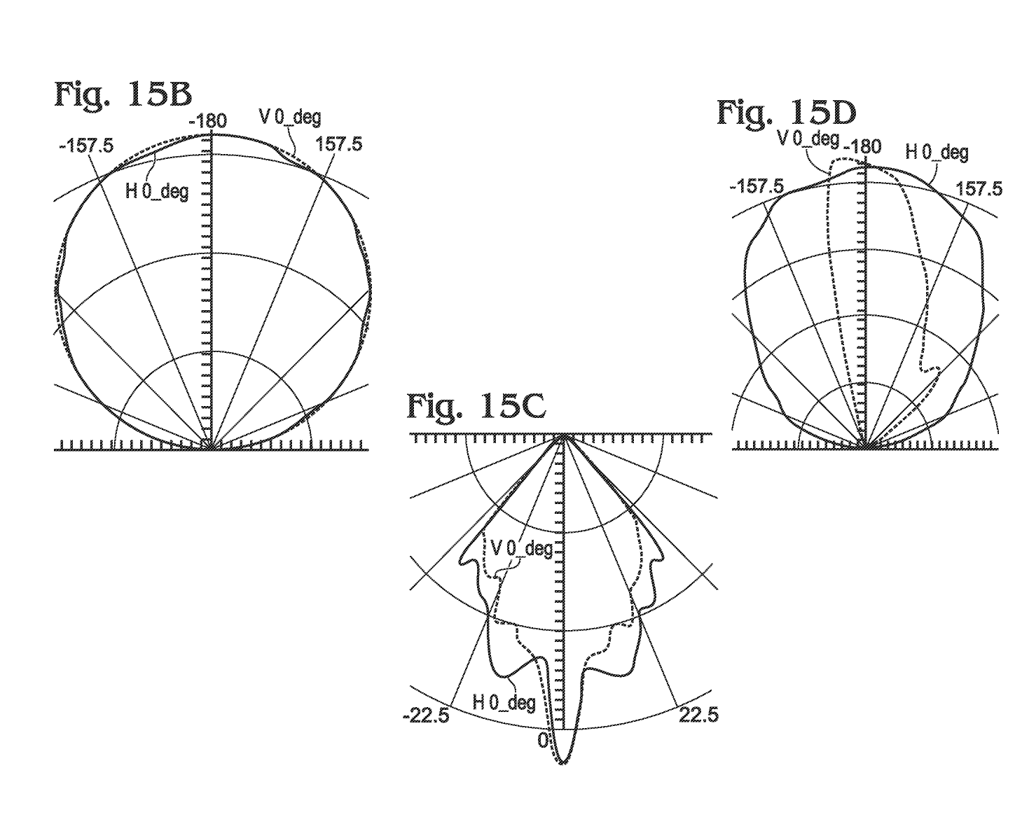

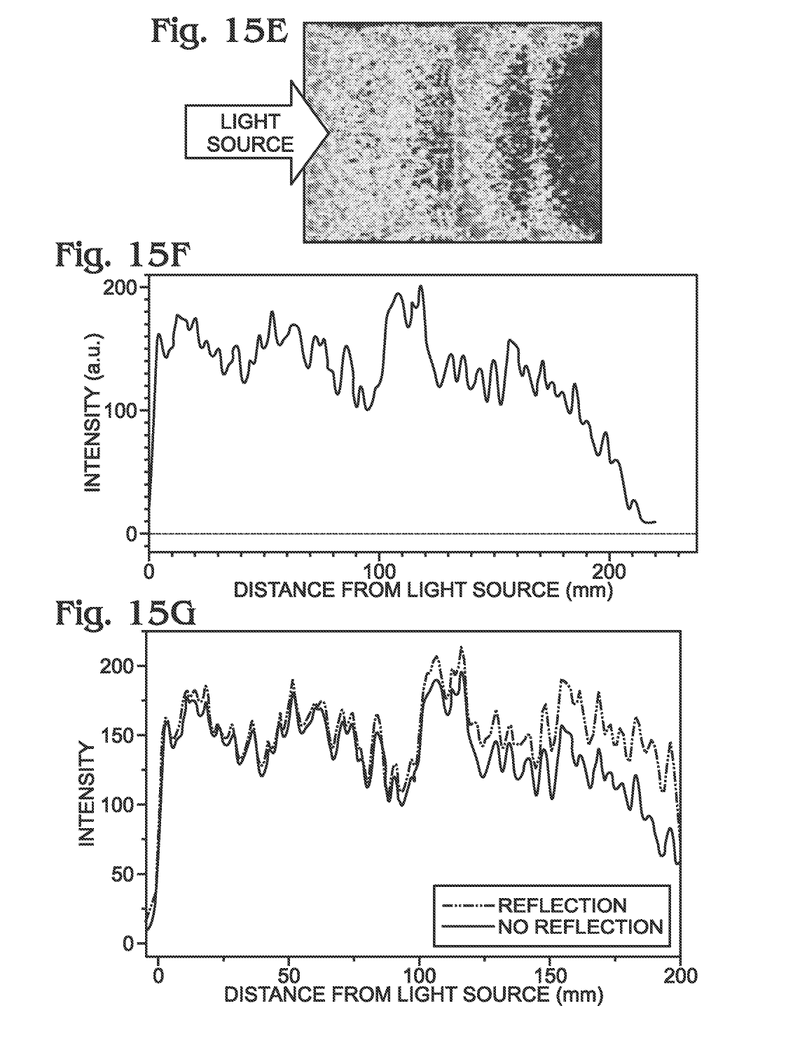

As shown, the subpanel may be divided into a plurality of segments having unequal widths that increase as a function of distance from the light sources. As can be seen in the extracted light intensity graphs of FIGS. 3 and 5, the ideal light extraction features designed to be nearer the light source are not the same as the ideal light extraction features designed to be farther from the light source. A design that strikes a compromise between the two properties typically results in the ramp function. The peak of the ramps can be attenuated by using a greater number of segments. As described in greater detail below, the light extraction features in segments nearer the light source have more effect on light extraction. Therefore, light extraction can be more successfully controlled by adding more segments, closer to the light source. Alternatively or in addition, the n subpanels may have unequal widths that increase as a function of distance from the light sources (see FIG. 15A).

### Functional Description

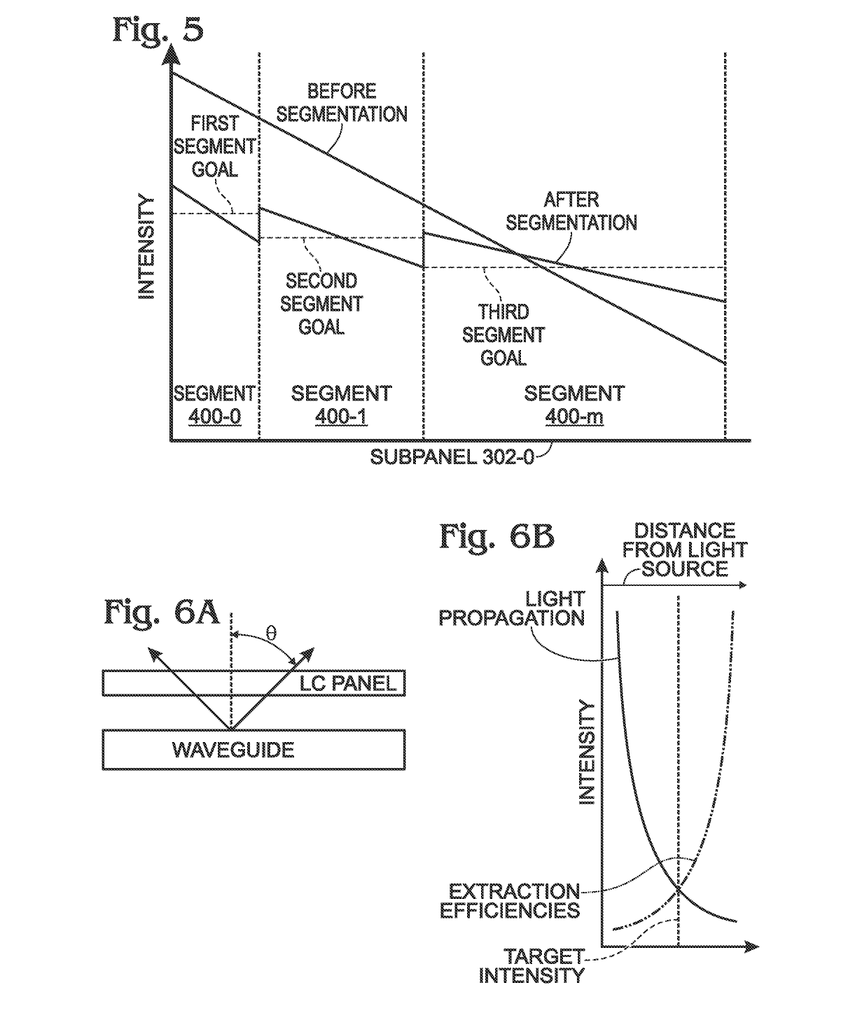

FIGS. 6A and 6B are, respectively, graphs depicting target goals for light extraction angles and intensity.

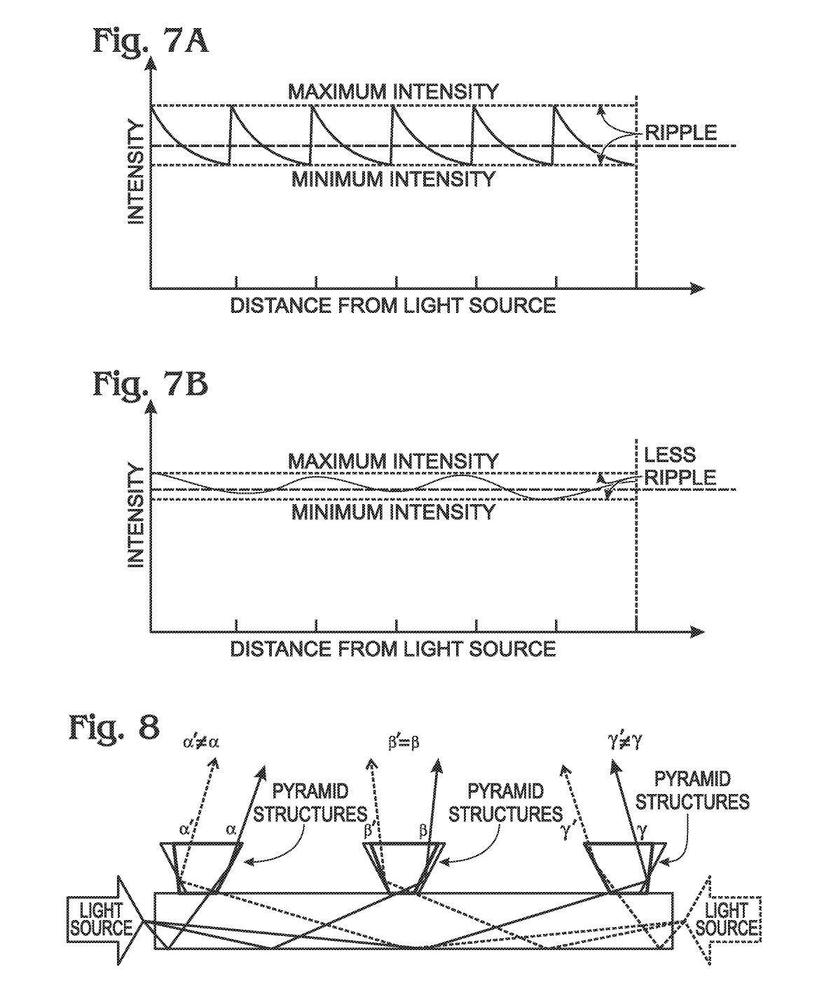

FIGS. 7A and 7B depict, respectively, initial light intensity extraction modeling, followed by a subsequent modeling iteration. By adjusting the light extraction features against light propagation through the waveguide, ripple or discrete ramp response can be minimized.

FIG. 8 is a partial cross-sectional view of a waveguide panel showing angular deflection of light propagating through the panel with two light sources. Also shown are the angles of light extracted from the waveguide with reference to a viewer's left and right eyes. Inverted pyramid structures on the waveguide top surface are used as a light extraction feature.

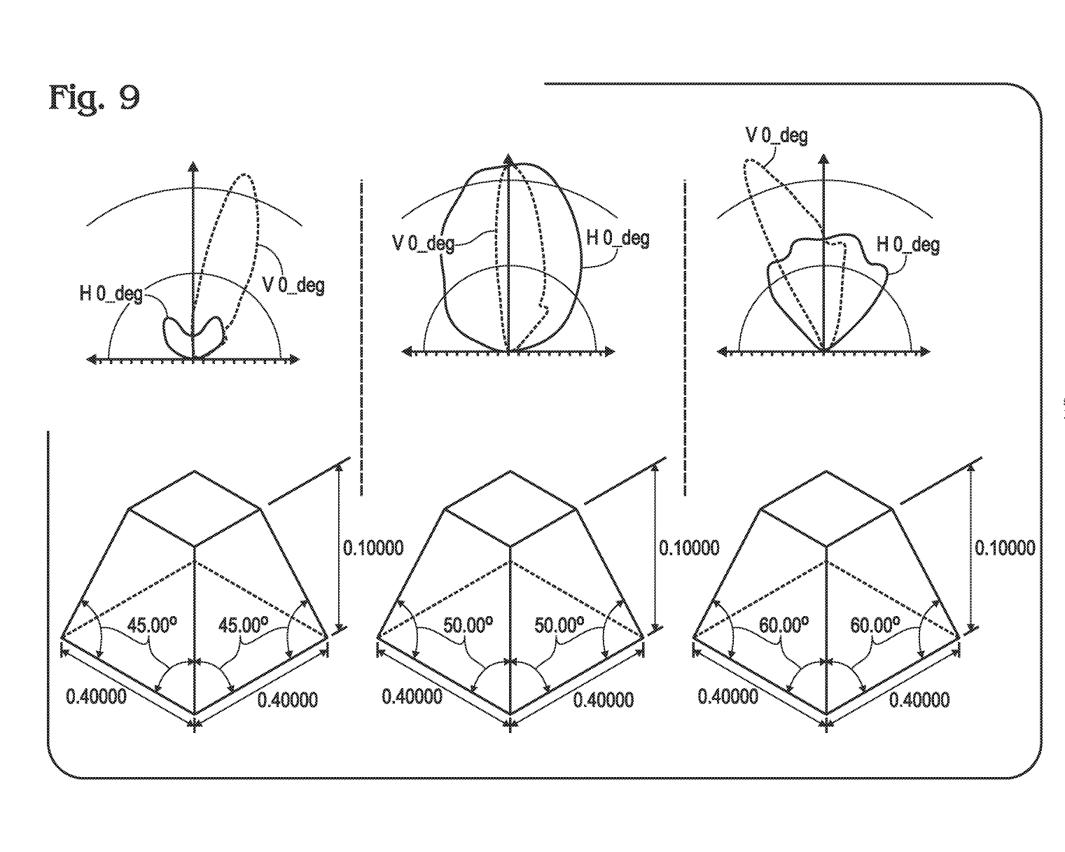

FIG. 9 depicts polar graphs of light extraction angles as a function of the shape of a pyramid-shaped light extraction feature. The horizontal (H) and vertical (V) patterns refer to extracted light that is “up” with respect to the drawings sheet in a plane parallel to the drawing sheet surface, and an orthogonal plane “into” the drawings sheet surface.

In addition to the angular controls, the light extraction efficiencies for particular extraction subpanels and extraction feature structures, including densities, can be quantified with light decay models using:

E(x)=A×exp(−x/τ)+A₀

where E(x) is the extracted light intensities, A is the peak intensities, A₀<<A, reflects the background signals, and τ is the decay constant.

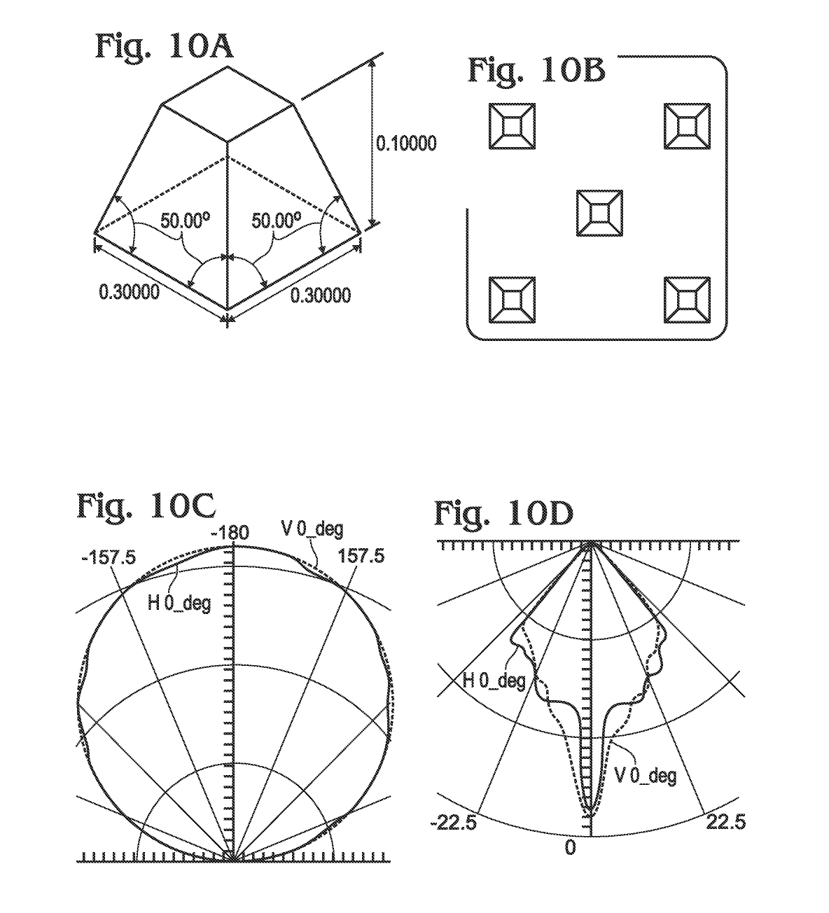

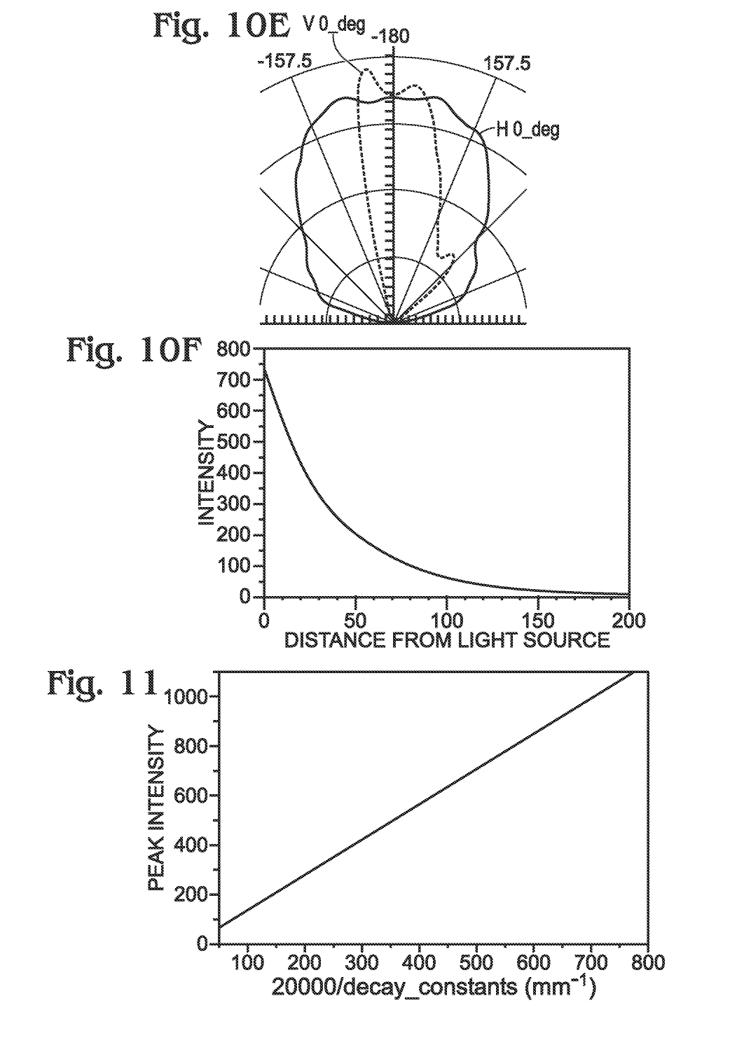

FIGS. 10A through 10E depict modeling with the objective of obtaining target angular and intensity light extraction goals. FIG. 10A depicts an exemplary pyramid-shaped light extraction feature, and FIG. 10B represents the density of the pyramid structures on the waveguide panel surface. FIG. 10C depicts the angular distribution of light from the light source into the side of a waveguide panel in two dimensions horizontal (H) and vertical (V), one parallel the drawing sheet surface, and one orthogonal to the drawing sheet surface, going “into” the page. FIG. 10D depicts the angular distribution of light out of the waveguide bottom surface, which is “down” on the drawings sheet, in the H and V planes as defined above. FIG. 10E depicts the angular distribution of light out of the waveguide top surface in the and V planes as defined above. FIG. 10F is a graph depicting extracted light intensity as a function of distance from the light source.

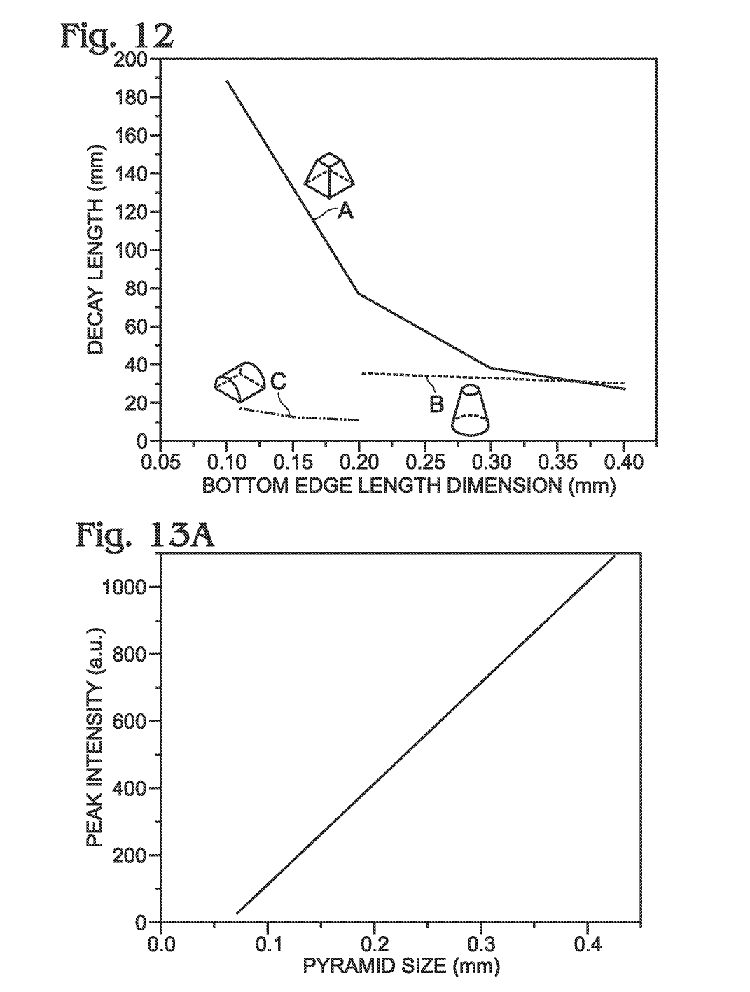

FIG. 11 is a graph depicting the relationship between light intensity (A) and the decay length (τ) of light of light propagation through the waveguide. It is clear from the graph that both A and τ can be used to quantify the extraction efficiencies since they are inversely proportion to each other.

FIG. 12 is a graph depicting different extraction rates (using decay lengths) for extraction cells with various light extraction structures having the same cell densities. Curve A is associated with a pyramid structure, curve B with a frustum-conical structure, and curve C with a semi-cylindrical structure. The x axis represents the lengths of the pyramid bottom square, where the bottom edge is the edge in contact with the waveguide top surface (curve A), the radius of the bottom (largest) cone diameter, where the bottom cone diameter is in contact with the waveguide top surface (curve B), and the length of the semi-cylinder in contact with the waveguide top surface (curve C).

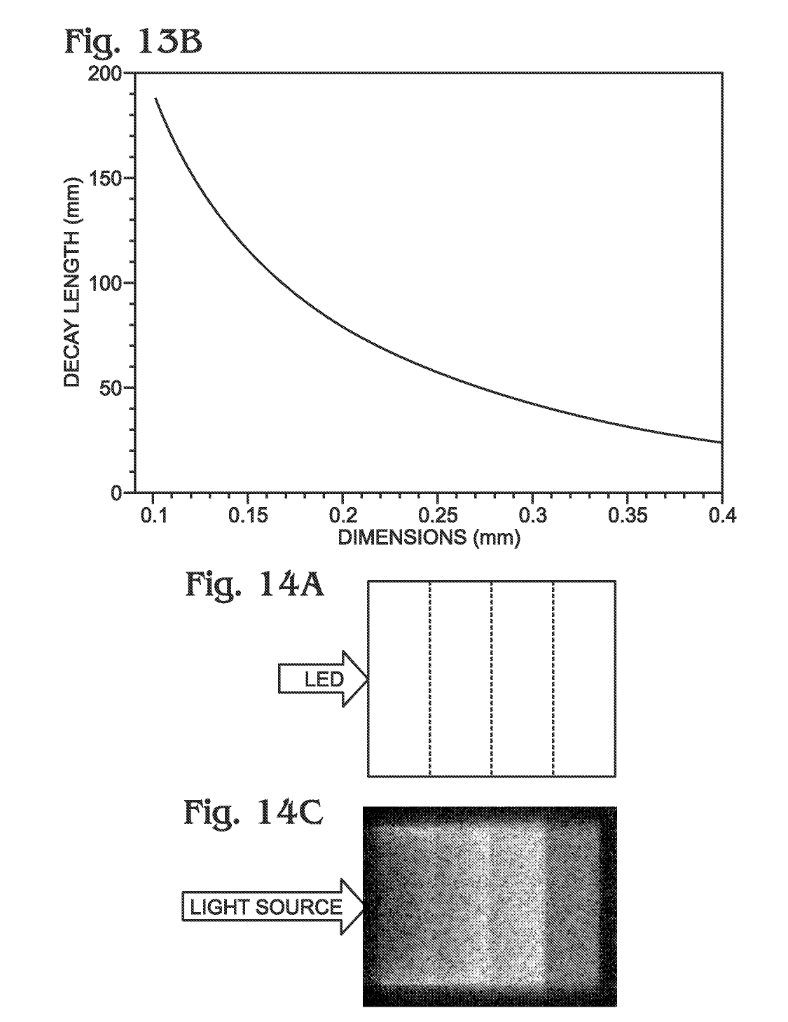

FIGS. 13A and 13B depict the relationship between the sizes of pyramids and light intensity (FIG. 13A), and decay length (FIG. 13B). Either light intensity or decay length can be used to quantify the extraction efficiencies since they are linearly correlated. In this example, the edge lengths of the “bottom” square of the pyramids vary, while the angles remain fixed at approximately 55 degrees.

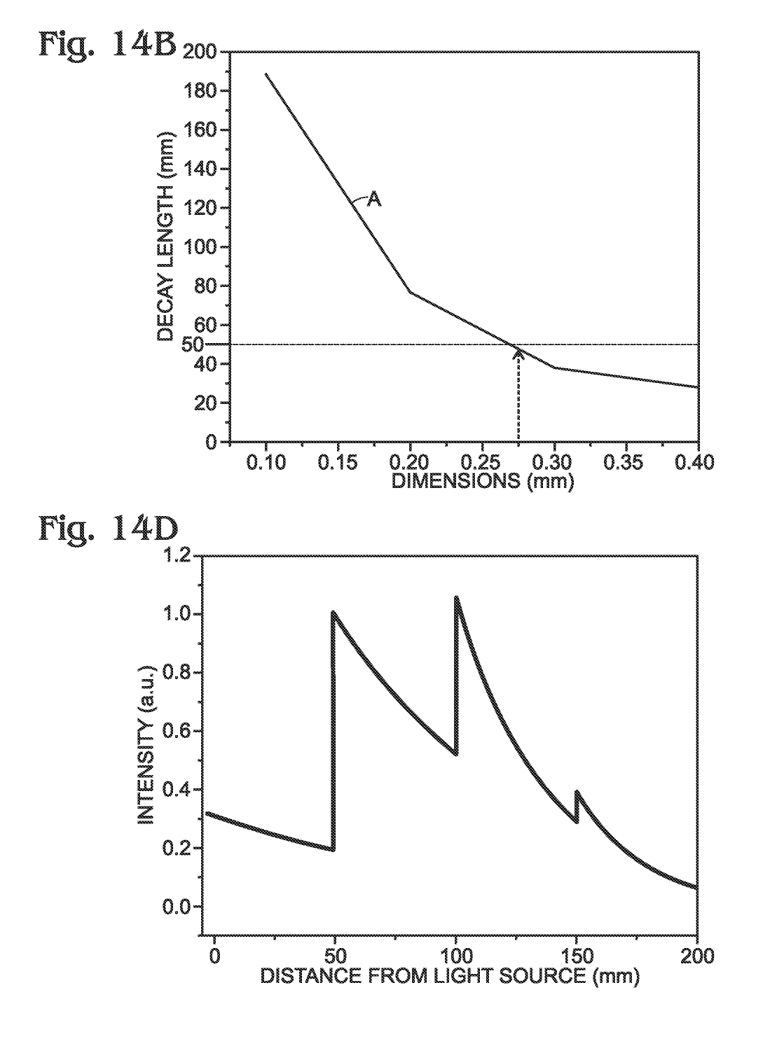

FIGS. 14A through 14E depict an example of a waveguide design begun by divided a panel into four subpanels (n=4). Referring to FIG. 14B, pyramid light extraction features are chosen, see curve A of FIG. 12. Since the decay length curve for the pyramid structures begins to flatten out at 50 mm, a pyramid size of 0.275 is selected. The representation of the panel as seen from above shows that the first and last subpanels emit less light than the two middle subpanels (FIG. 14C). The emission intensity is depicted graphically in FIG. 14D. FIG. 14E depicts the propagation of light through the waveguide panel. As shown, at least part of the reason for the low intensity of extracted light from the fourth subpanel (150 mm to 200 mm) is due to the low intensity of light propagating into the subpanel.

FIGS. 15A through 15G represent a modification to the design of FIGS. 14A through 14E. As shown is FIG. 15A, the width of the panels remains constant, but the bottom edges of the pyramid structures are made progressively larger in each panels as a function of the distance from the light source. That is, the pyramid bottom edges in the first panel next to the light source are 0.135. The bottom edges are 0.15 in the second panel, 0.19 in the third panel, and 0.23 in the fourth panel. FIG. 15B depicts the angular distribution of light of light entering the waveguide panel from the light source in two dimensions, horizontal (H) and vertical (V) as defined above. FIG. 15C depicts the angular distribution of light out of the waveguide bottom surface (“down”), in the H and V planes. FIG. 15D depicts the angular distribution of light out (“up”) of the waveguide top surface in the and V planes. The representation of the panel as seen from above shows that that the last subpanel still emits less light than the other subpanels (FIG. 15E). The extraction intensity is depicted graphically in FIG. 15F. After redefining the propagation restrictions by adding a mirror to the end of the fourth panel, light extraction from the fourth panel can be improved (FIG. 15G).

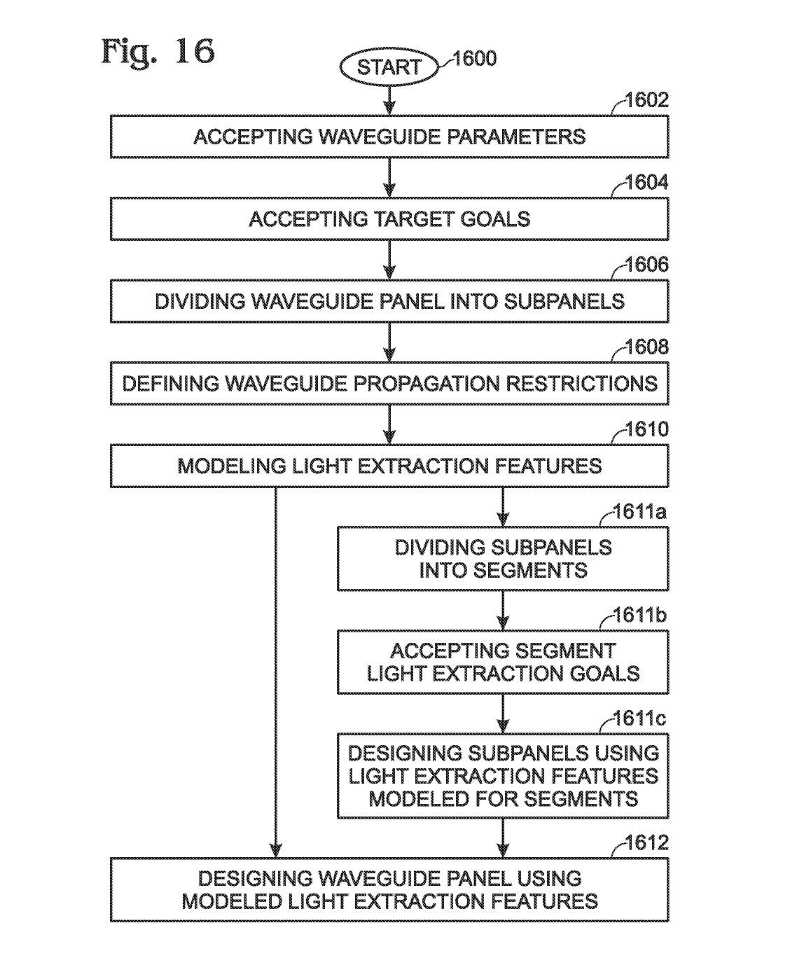

FIG. 16 is a flowchart illustrating a set of software instructions, stored as a sequence of steps in a non-transitory memory for execution by a processor, for designing a waveguide with uniform light extraction. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 1600.

Step 1602 accepts parameters for a waveguide panel, light sources, and light extraction features associated with the waveguide panel. Step 1604 accepts first target light extraction goals. Some examples of first target light extraction goals include the uniformity of light intensity exiting a top surface of the waveguide panel, light exiting a bottom surface of the waveguide panel, light angles exiting the top and bottom surfaces of the waveguide panel, and spatial resolution between light exiting regions. Step 1606 divides the waveguide panel into n subpanels, where n is an integer greater than 1. In one aspect, the subpanels have unequal widths that increase as a function of distance from the light sources. For each subpanel, Step 1608 defines waveguide propagation restrictions. For each subpanel, Step 1610 models the light extraction features in response to the first target extraction goals. Step 1612 designs the waveguide panel using the light extraction features modeled for each subpanel.

In one aspect, modeling light extraction features in Step 1610 includes modeling light extraction features such as waveguide top surface roughness, microstructures embedded in the waveguide panel, microstructures overlying the waveguide panel, and combinations of the above-referenced features. Defining light propagation restrictions in Step 1608 includes defining restrictions such as the intensity of light entering a subpanel, the intensity of light propagated to a subsequent subpanel, angular deflection of light through a subpanel, the intensity of reflected light entering a subpanel, and the combination of the above-listed restrictions.

In one aspect, subsequent to modeling the light extraction features for a first subpanel in Step 1610, Step 1611a divides the first subpanel into a plurality of segments. In one aspect, the first subpanel is divided into a plurality of segments having unequal widths that increase as a function of distance from the light sources. Step 1611b accepts segment light extraction goals. For each first subpanel segment, Step 1611c models the light extraction features in response to the segment light extraction goals. Then, Step 1612 designs the first subpanel using the light extraction features modeled for each segment. Using a similar analysis, Step 1611a may divide every subpanel into a plurality of segments, and Step 1611h may accept segment light extraction goals for each subpanel. Then, Step 1611c models the light extraction features for the segments in each subpanel.

As described in the examples above, defining the waveguide propagation restrictions in Step 1608 may include defining the intensity of light entering each segment of the first subpanel. Then, modeling light extraction features in Step 1610 includes adjusting the light extraction feature modeling of the first subpanel segments in response to redefining the intensity of light entering each segment. If Step 1611a divides every subpanel into a plurality of segments, then Step 1608 defines the intensity of light entering each segment of each subpanel, and Step 1610 adjusts the light extraction features for each segment in each sub-panel, in response to redefining the intensity of light entering each segment.

A system and method have been provided for designing a waveguide. Examples of particular light extraction features, such a pyramid shapes formed on the waveguide top surface, have been presented to illustrate the invention. However, the invention is not limited to merely these examples. Other variations and embodiments of the invention will occur to those skilled in the art.

We claim:

1. A set of software instructions, stored as a sequence of steps in a non-transitory memory for execution by a processor, for designing a waveguide with uniform light extraction, the instructions describing a method comprising:
accepting parameters for a waveguide, panel, light sources, and light extraction features associated with the waveguide panel;
accepting first target light extraction goals;
dividing the waveguide, panel into n subpanels, where n is an integer greater than 1;
for each subpanel, defining waveguide propagation restrictions;
for each subpanel, modeling the light extraction features in response to the first target extraction goals; and,
designing the waveguide panel using the light extraction features modeled for each subpanel.

2. The method of claim 1 wherein modeling light extraction features includes the light extraction features being selected from a group consisting of waveguide top surface roughness, microstructures embedded in the waveguide panel, microstructures overlying the waveguide panel, and combinations of the above-referenced features.

3. The method of claim 1 wherein defining light propagation restrictions includes defining restrictions selected from a group consisting the intensity of light entering a subpanel, the intensity of light propagated to a subsequent subpanel, angular deflection of light through a subpanel, and the intensity of reflected light entering a subpanel.

4. The method of claim 1 wherein accepting the first target light extraction goals includes accepting goals selected from a group consisting of uniformity of light intensity exiting a top surface of the waveguide, panel, light exiting a bottom surface of the waveguide panel, light angles exiting the top and bottom surfaces of the waveguide panel, and spatial resolution between light exiting regions.

5. The method of claim 1 further comprising:
subsequent to modeling the light extraction features for a first subpanel, dividing the first subpanel into a plurality of segments;
accepting segment light extraction goals;
for each first subpanel segment, modeling the light extraction features in response to the segment light extraction goals; and,
wherein designing the waveguide panel includes designing the first subpanel using the light extraction features modeled for each segment.

6. The method of claim 5 wherein dividing the first subpanel into the plurality of segments includes dividing every subpanel into a plurality of segments;
wherein accepting the segment light extraction goals for the first subpanel includes accepting segment light extraction goals for each subpanel; and,
wherein modeling the light extraction features, for each first sub-panel segment, in response to the segment light extraction goals includes modeling the light extraction features for the segments in each subpanel.

7. The method of claim 5 wherein defining the waveguide propagation restrictions includes defining the intensity of light entering each segment of the first subpanel; and,
wherein modeling light extraction features includes adjusting the light extraction feature modeling of the first subpanel segments in response to redefining the intensity of light entering each segment.

8. The method of claim 7 wherein dividing the first subpanel into the plurality of segments includes dividing every subpanel into a plurality of segments;
wherein defining the intensity of light entering each segment of the first subpanel includes defining the intensity of light entering each segment of each subpanel; and,
wherein adjusting the light extraction feature modeling of the first subpanel segments includes adjusting the light extraction features for each segment in each sub-panel, in response to redefining the intensity of light entering each segment.

9. The method of claim 5 wherein dividing the first subpanel into a plurality of segments includes the segments having unequal widths that increase as a function of distance from the light sources.

10. The method of claim 1 wherein dividing the waveguide panel into n subpanels includes the subpanels having unequal widths that increase as a function of distance from the light sources.

11. A system for designing a waveguide with uniform light extraction, the device comprising:
a non transitory memory;
a processor; and,
a design application enabled as a sequence of instructions stored in the memory and executed by the processor, the design application accepting parameters for a waveguide panel, light sources, light extraction features associated with the waveguide panel, and first target extraction goals, the design application dividing the waveguide panel into n subpanels, where n is an integer greater than 1, defining waveguide, propagation restrictions for each subpanel, modeling the light extraction features for each subpanel in response to the first target extraction goals, and designing the waveguide panel using the light extraction features modeled for each subpanel.

12. The system of claim 11 wherein the design application models light extraction features selected from a group consisting of waveguide top surface roughness, microstructures embedded in the waveguide panel, microstructures overlying the waveguide panel, and combinations of the above-referenced features.

13. The system of claim 11 wherein the design application defines light propagation restrictions selected from a group consisting the intensity of light entering a subpanel, the intensity of light propagated to a subsequent subpanel, angular deflection of light through a subpanel, and the intensity of reflected light entering the subpanel.

14. The system of claim 11 wherein the design application accepts first target light extraction goals selected from a group consisting of uniformity of light intensity exiting a top surface of the waveguide panel, light exiting a bottom surface of the waveguide panel, light angles exiting the top and bottom surfaces of the waveguide panel, and spatial resolution between light exiting regions.

15. The system of claim 11 wherein the design application, subsequent to modeling the light extraction features for a first subpanel, divides the first subpanel into a plurality of segments, accepts segment light extraction goals, models the light extraction features in response to the segment light extraction goals for each first subpanel segment, and designs the first subpanel using the light extraction features modeled for each segment.

16. The system of claim 15 wherein the design application divides every subpanel into a plurality of segments, accepts segment light extraction goals for each subpanel, and models the light extraction features for the segments in each subpanel.

17. The system of claim 15 wherein the design application defines the intensity of light entering each segment of the first subpanel, and adjusts the light extraction feature modeling of the first subpanel segments in response to redefining the intensity of light entering each segment.

18. The system of claim 17 wherein the design application divides every subpanel into a plurality of segments, defines the intensity of light entering each segment of each sub-panel, and adjusts the light extraction features for each segment in each subpanel in response to redefining the intensity of light entering each segment.

19. The system of claim 11 wherein the design application divides the first subpanel into a plurality of segments having unequal widths that increase as a function of distance from the light sources.

20. The system of claim 11 wherein the backlight design application divides the waveguide panel into n subpanels having unequal widths that increase as a function of distance from the light sources.
